(19) United States
(12) Patent Application Publication
(10) Pub. No.: US 2019/0148804 A1
(43) Pub. Date: May 16, 2019

(54) HYBRID AIR-SLURRY FLOW CELL BATTERY

(71) Applicant: QATAR FOUNDATION FOR EDUCATION, SCIENCE AND COMMUNITY DEVELOPMENT, DOHA (QA)

(72) Inventors: BELABBES MERZOUGUI, DOHA (QA); AHMED SODIQ, DOHA (QA); RACHID ZAFFOU, DOHA (QA); LAGNAMAYEE MOHAPATRA, DOHA (QA)

(21) Appl. No.: 16/194,202

(22) Filed: Nov. 16, 2018

Related U.S. Application Data
(60) Provisional application No. 62/587,319, filed on Nov. 16, 2017.

(51) Int. Cl. H01M 12/08; H01M 12/06; H01M 6/04; H01M 8/18

(52) U.S. Cl. CPC H01M 12/08; H01M 8/188; H01M 6/045; H01M 12/06

(57) ABSTRACT

The hybrid air-slurry flow cell battery is at least one flow cell having a core area having an anode, a cathode parallel to the anode, and an ion-selective membrane disposed between the anode and the cathode to define parallel anolyte and catholyte flow paths through the core area on opposite sides of the membrane. An electrolyte tank is connected to the input and output of one of the flow paths to circulate a slurry containing a first electrochemically active redox reactant adsorbed on carbon particles suspended in a solvent between the electrolyte tank and the flow path through the core area. A gas diffusion electrode is connected to the other flow path, the gas (preferably air or oxygen) including a second electrochemically active redox reactant forming a redox couple with the first. A redox reaction across the membrane generates a voltage differential between the electrodes.

### CROSS-REFERENCE TO RELATED APPLICATION

This application claims the benefit of U.S. Provisional Patent Application Ser. No. 62/587,319, filed on Nov. 16, 2017.

### BACKGROUND

### 1. Field

The disclosure of the present patent application relates to batteries, and particularly to a hybrid air-slurry flow cell battery that generates electrical current from a redox slurry electrode and a gas diffusion electrode across an ion-selective membrane.

### 2. Description of the Related Art

A flow battery, or redox flow battery, is a type of rechargeable battery or fuel cell in which chemical energy is provided by two chemical components dissolved in liquids contained within the system and separated by a membrane. Ion exchange (accompanied by flow of electric current) occurs through the membrane while both liquids circulate in their own respective space. Cell voltage is chemically determined by the Nernst equation and ranges, in practical applications, from 1.0 to 2.2 V, and is particularly dependent on the nature of the electrolyte/solvent and whether it is aqueous or non-aqueous. A flow battery may be used like a fuel cell (where the spent fuel is extracted and new fuel is added to the system) or like a rechargeable battery (where an electric power source drives regeneration of the fuel). While flow batteries have technical advantages over conventional rechargeable batteries (i.e., solid state batteries), such as potentially separable liquid tanks and near unlimited longevity, current implementations are comparatively less powerful and require more sophisticated electronics. The energy capacity is a function of the electrolyte volume (amount of liquid electrolyte) and the power is a function of the surface area and nature of the electrodes.

FIG. 2 illustrates a conventional flow cell 100, where a liquid anolyte is stored in anolyte tank 102 and is driven to flow into the anolyte side 112 of a core area by a conventional pump 118. The core area is disposed between two electrodes 106, 108 and has an ion-selective membrane 116 between the electrodes 106, 108 separating the core area into an anolyte side 112 and a catholyte side 114. Pump 118 drives the liquid anolyte electrolyte to flow through the anode side 112 and recirculate back to the anolyte tank 102. Similarly, a conventional pump 120 circulates a liquid catholyte electrolyte from catholyte tank 104, through the cathode side 114, and back to the catholyte tank 104. A redox reaction takes place at the surface of electrode interfacing at ion-selective membrane 116, resulting in ion transfer and a potential differential between the anode 106 and the cathode 108. An electrical load may then be powered through connection across the negative and positive collector plates 106, 108. The load may be replaced by a battery with the polarity reversed to recharge the respective electrolytes.

FIG. 3 illustrates a conventional semi-solid flow cell 200, or slurry flow cell, which is similar in operation to the conventional flow cell 100 of FIG. 2, but where the positive and negative electrodes are composed of particles suspended in a carrier liquid (i.e., the electrolyte). An anolyte slurry is stored in anolyte tank 202 and is driven to flow through an anolyte side 212 of the core area by a conventional pump 218. The anolyte slurry is formed from anode particles AP and carbon particles (typically particles of carbon black CB) suspended in a carrier liquid, resulting in a relatively viscous slurry. The core area is disposed between a electrodes 206, 208 and an ion-selective membrane 216 divides the core area into an anolyte side 212 and a catholyte side 214. Pump 218 drives the anolyte slurry to flow through the anolyte side 212 and recirculate back to the anolyte tank 202. Similarly, a conventional pump 220 circulates a catholyte slurry from catholyte tank 204 through the catholyte side 214 of the core area and back to the catholyte tank 204. Similar to the anolyte slurry, the catholyte slurry is foamed from cathode particles CP and carbon black CB suspended in a liquid carrier, also forming a relatively viscous slurry. The redox reaction takes place across ion-selective membrane 216, resulting in a potential differential between the anode 206 and the cathode 208. The electrical load may then be powered through connection across the negative and electrodes 206, 208. The load in FIG. 3 may be replaced by a battery oriented with the proper polarity for recharging the electrolytes.

Although conventional flow cells and conventional slurry flow cells, such as those described above, have numerous advantages, they also suffer from numerous problems, particularly in their implementation as practical power supplies. The energy densities (both (volumetric and gravimetric) of such cells vary considerably, but in general are lower than those of traditional portable batteries, such as conventional lithium-ion batteries. Also, when compared to non-reversible fuel cells or electrolyzers, which use similar electrolytic chemistries, flow batteries generally have somewhat lower efficiencies. Further, the component costs of flow cells presently makes them impractical for personal or industrial scale use, particularly due to their requirements of dual circulation pumps and dual tanks. This issue also affects the potential portability of such cells. Thus, a hybrid air-slurry flow cell battery solving the aforementioned problems is desired.

### SUMMARY

The hybrid air-slurry flow cell battery is a rechargeable battery that generates electrical current from a redox reaction between an anolyte (or catholyte) slurry and a gas (preferably from an air/oxygen gas diffusion electrode) across an ion-selective membrane. The hybrid air-slurry flow cell includes an anolyte tank for storing an anolyte slurry. The anolyte slurry is formed from anode particles and carbon particles suspended in a carrier liquid. For example, the anolyte slurry may be formed from sodium sulfide particles adsorbed on carbon particles suspended in an aqueous solution of potassium hydroxide or sodium hydroxide.

The anolyte tank is in fluid communication with a redox reaction cell, which includes an anode, a cathode, and an ion-selective membrane. The ion-selective membrane is positioned between the anode and the cathode to define a core area having an anolyte side between the anode and the membrane and a catholyte side between the membrane and the cathode. The ion-selective membrane may be any suitable type of ion-selective membrane, such as those conventionally used in flow cells. For example, the ion-selective membrane may be formed from Nafion®, manufactured by E.I. Du Pont De Nemours & Co. of Delaware.

The anolyte slurry is recirculated through the anolyte side of the core area and the anolyte tank such that a redox reaction takes place across the ion-selective membrane between the anolyte slurry and air or oxygen flowing through the cathode flow field. The redox reaction generates an electrical potential difference between the anode and the cathode, allowing an electrical load to be connected across the electrodes for receiving electrical power. It should be understood that the gas may be either pure O₂ or may be oxygen contained in ambient environmental air.

Further, it should be understood that a plurality of the redox reaction cells may be connected together to form a battery of the cells. It should be additionally understood that the hybrid air-slurry flow cell may be operated using a catholyte slurry; i.e., rather than a redox reaction occurring between the anolyte slurry and the gaseous oxygen across the ion-selective membrane, a redox reaction could take place between a catholyte slurry and an appropriate gas, e.g., hydrogen, across the ion-selective membrane.

These and other features of the present invention will become readily apparent upon further review of the following specification.

### BRIEF DESCRIPTION OF THE DRAWINGS

FIG. 1 is a schematic diagram of a hybrid air-slurry flow cell battery.

FIG. 2 is a schematic diagram of a conventional prior art flow battery.

FIG. 3 is a schematic diagram of a conventional prior art slurry flow battery.

FIGS. 4A and 4B are plots of voltage as a function of current for the hybrid air-slurry flow cell battery for different currents and different concentrations of carbon, including a comparison for a zero carbon control sample.

Similar reference characters denote corresponding features consistently throughout the attached drawings.

### DETAILED DESCRIPTION OF THE PREFERRED EMBODIMENTS

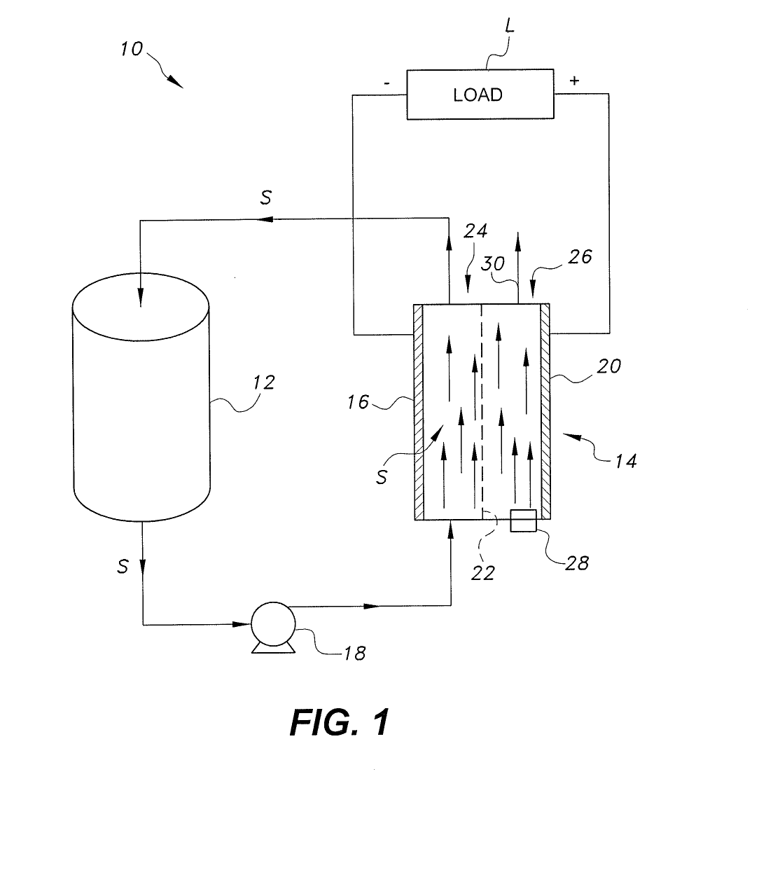

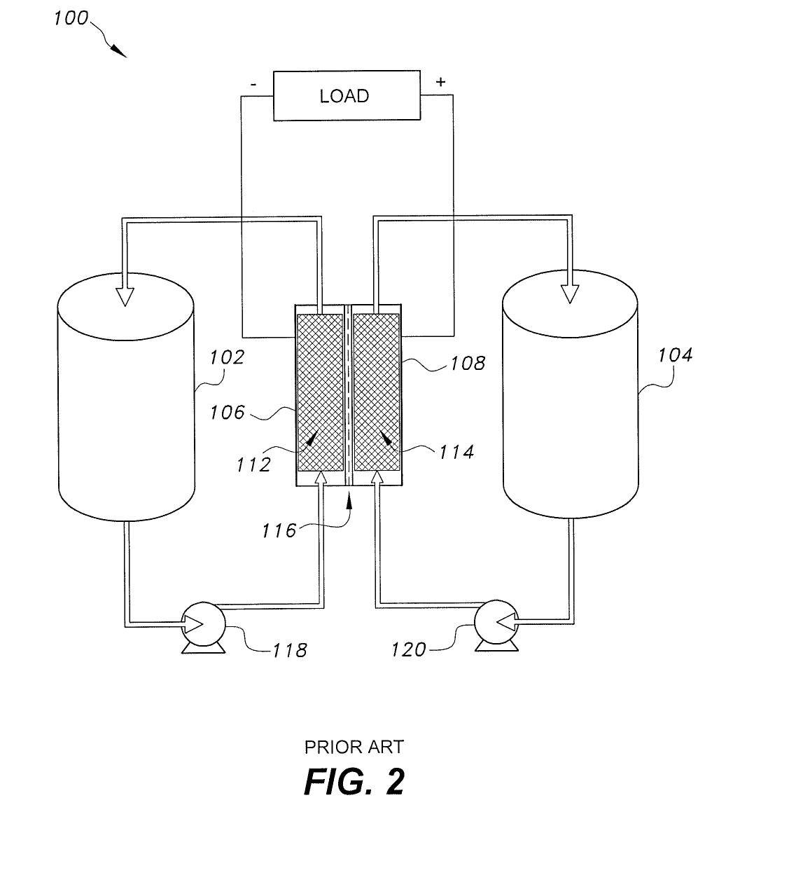

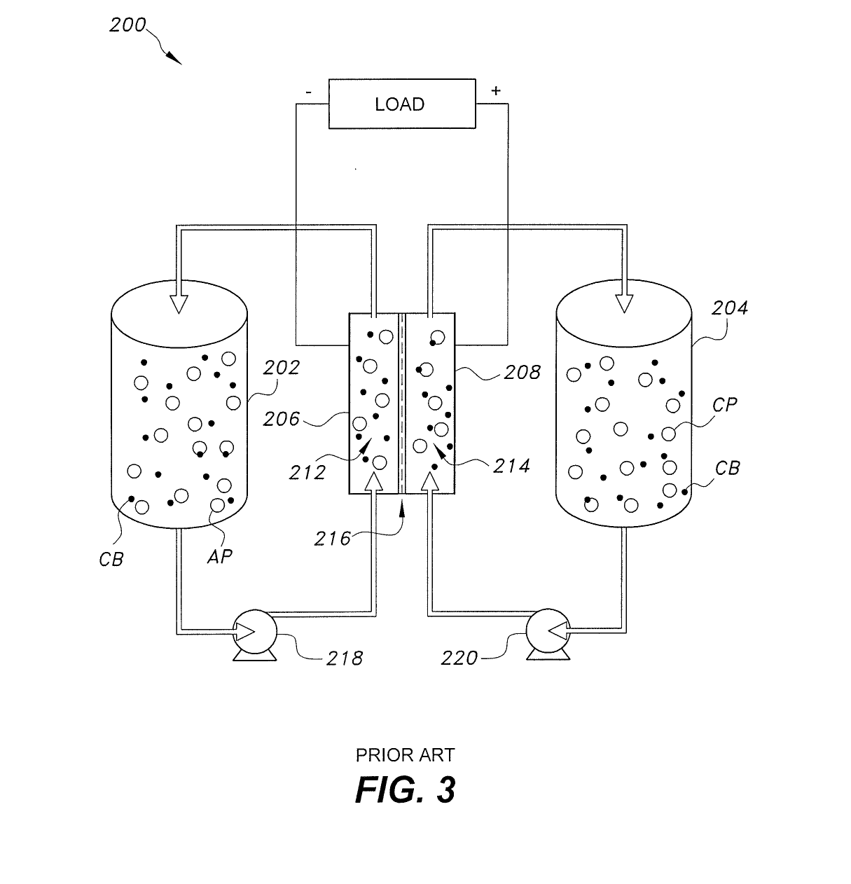

The hybrid air-slurry flow cell battery 10 is a rechargeable battery that generates electrical current from a redox reaction between an anolyte (or catholyte) slurry and a gas (preferably from an air/oxygen gas diffusion electrode) across an ion-selective membrane 22. As shown in FIG. 1, the hybrid air-slurry flow cell 10 includes an anolyte tank 12 for storing an anolyte slurry S. The anolyte slurry S is formed from an oxidant and carbon particles suspended in a solvent. For example, the anolyte slurry S may be formed from sodium sulfide particles and carbon particles (which may be particles of activated carbon) suspended in an alkaline solvent, such as aqueous potassium hydroxide solution. Aqueous sodium hydroxide may also be used, as well as a combination of potassium hydroxide solution and sodium hydroxide solution. It should be understood that any suitable type of electrochemically active redox reactant may be used, such as a suitable electrochemically active redox reactant having a redox potential ranging between 0 V/RHE in aqueous solution to −1 V/RHE in aqueous solution, or a suitable electrochemically active redox reactant having a redox potential ranging between 0 V/RHE in non-aqueous solution to −3 V/RHE in non-aqueous solution. It should be understood that any suitable type of carbon particles may be used. In a non-limiting example, the carbon particles have a concentration of between 0 wt % and 10 wt % with respect to the electrolyte, and each carbon particle may have a surface area density ranging between 100 and 2000 m²/g. It should be further understood that the carbon particles may have any suitable shape or form, including but not limited to, spheres, cubes, rods, needles, tubes and combinations thereof.

The anolyte tank 12 is in fluid communication with the anolyte side 24 of the core area 14 of a redox reaction cell, which includes an anode 16 (e.g. graphite), a cathode 20, (e.g., graphite), and an ion-selective membrane 22. The ion-selective membrane 22 is positioned between the electrodes 16, 20, and defines an anolyte side 24 or anolyte flow path between the anode 16 and the ion-selective membrane 22, and further defines a catholyte side 26 of the core area 14 or catholyte flow path between the cathode 20 and the ion-selective membrane 22. The ion-selective membrane 22 may be any suitable type of ion-selective membrane, such as those conventionally used in flow cells. For example, the ion-selective membrane 22 may be formed from Nafion®, manufactured by E.I. Du Pont De Nemours & Co. of Delaware.

The anolyte slurry S is recirculated through the anolyte side 24 of the core area 14 and the anolyte tank 12 and a redox reaction takes place across the ion-selective membrane 22 between the anolyte slurry S and the gas (air or oxygen) flowing through the catholyte side 26 of the core area 14. An external pump 18 or the like is provided for driving recirculation of the anolyte slurry S through the anolyte tank 12 and the anolyte side 24 of the core area 14. The catholyte side 26 of the core area 14 may receive a stream of air or a stream of oxygen from a gas diffusion electrode 28, the gaseous stream 30 being purged or vented after passing through the core area 14, eliminating the need for a catholyte tank, since there is no electrolyte to recharge or recycle. The redox reaction across the membrane 22 generates an electrical potential difference between the electrodes 16, 20, allowing an electrical load L to be connected across the negative and positive current collector plates 16 20 for receiving electrical power.

It should be understood that the gas may be either pure O₂, or may be oxygen extracted from ambient environmental air by the diffusion electrode 28, or may be air. The oxygen is being reduced at the interface cathode-membrane, while the redox anolyte is being oxidized at the anode side. Further, it should be understood that a plurality of the redox reaction cells may be connected together to form a battery, or the battery may be a single cell, as shown in FIG. 1. It should be additionally understood that the hybrid air-slurry flow cell 10 may be operated using a catholyte slurry; i.e., rather than a redox reaction occurring between the anolyte slurry S and air or oxygen across the ion-selective membrane 22, a redox reaction could take place between a catholyte slurry and an appropriate gas (e.g., hydrogen) across the ion-selective membrane 22.

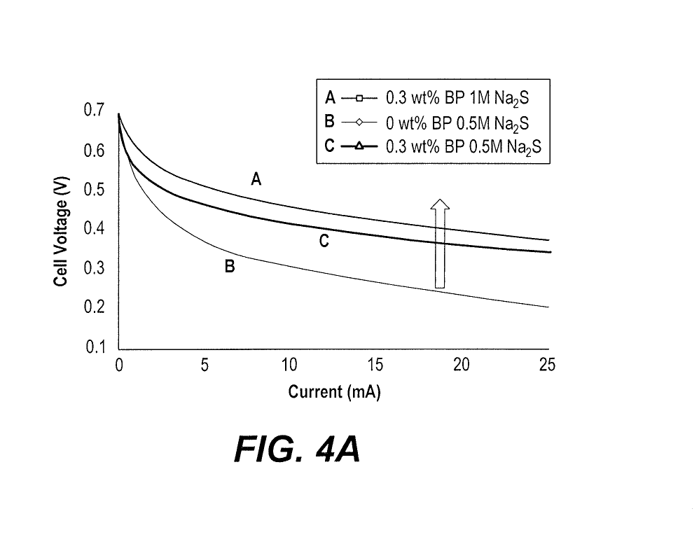

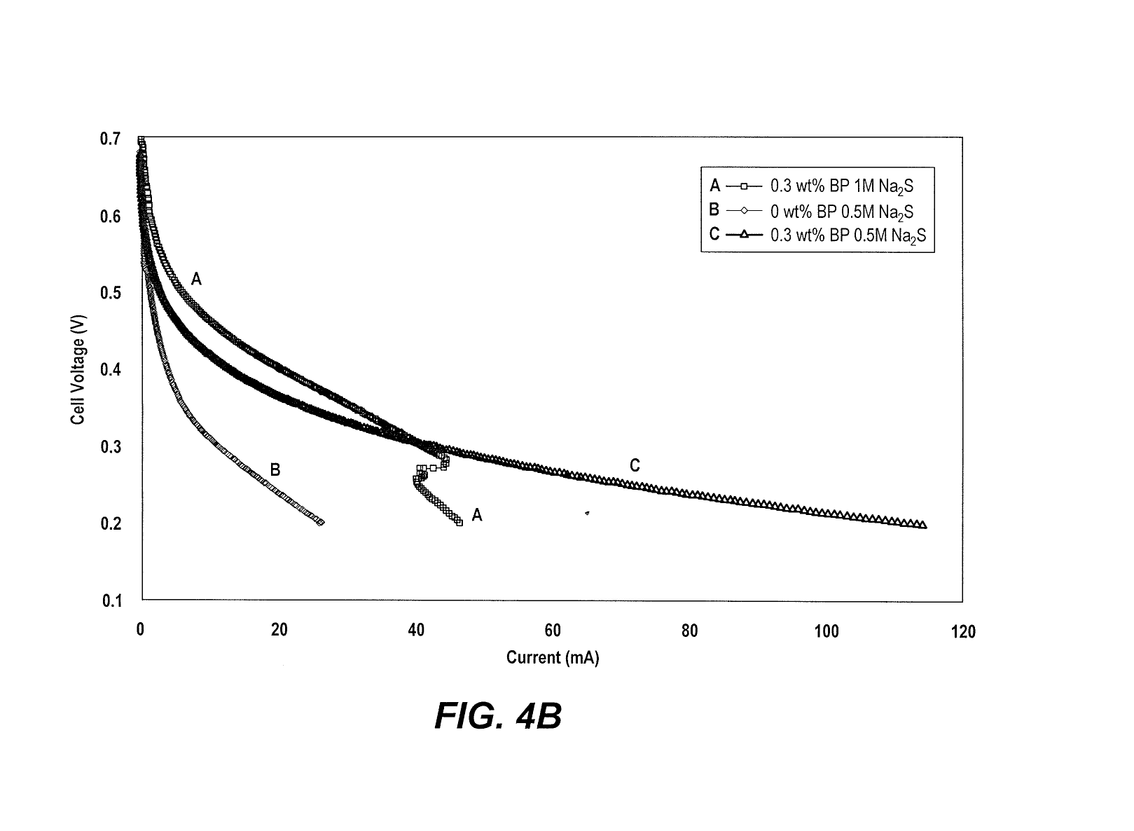

In order to test the hybrid air-slurry flow cell 10, an anolyte slurry was prepared using sodium sulfide mixed with carbon powder and dispersed in 1 M KOH. The hybrid air-slurry flow cell battery 10 generated an open circuit voltage in the range of 0.7 V. As shown in FIGS. 4A and 4B, the performance of the experimental hybrid air-slurry flow cell 10 increased almost five times (indicated by curve C of FIG. 4B) when compared against a conventional liquid-air cell (without a carbon slurry, represented in FIGS. 4A and 4B as 0 wt % carbon black particles (BP)). The performance of the hybrid air-slurry flow cell battery 10 also showed improvement with an increase in sulfide concentration in the anolyte slurry, particularly at low currents (i.e., the kinetic region). This indicates that the cell performance can depend only on the anolyte slurry. However, it was observed that at high currents, the cell experienced a sudden drop in performance, which may be attributed to the Nafion® separator (indicated by curve A of FIG. 4B). The use of an alkaline based anolyte and only air on the cathode side can trigger an imbalance in charge transport through the Nafion® membrane, leading to a loss in ionic conductivity between electrodes. It is worth noting that these three experiments were conducted in the following order: curve B, curve C and curve A (in FIG. 4B). Therefore, it is expected that the imbalance of charge occurred in the Nafion® due to conversion of Nafion® from hydrogen form to Na form as results of the redox reaction (i.e., sulfur oxidation) at the anode and oxygen reduction on the cathode side. Thus, it is recommended, for a Nafion® separator, to have an acidic anolyte so that the charge balance between the slurry anode and the air cathode will be satisfied.

It is to be understood that the hybrid air-slurry flow cell is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. A hybrid air-slurry flow cell battery, comprising at least one flow cell having:
a core area including an anode, a cathode parallel to the anode, and an ion-selective membrane between the anode and the cathode defining a core area having an anolyte flow path between the anode and the ion-selective membrane and a catholyte flow path between the cathode and the ion-selective membrane parallel to the anolyte flow path, the anolyte flow path and the catholyte flow path each having an input and an output;
an electrolyte tank having an outlet connected to the input of one of the flow paths through the core area and having an inlet connected to the output of the flow path connected to the outlet of the electrolyte tank;
an electrolyte circulating between the electrolyte tank and the flow path of the core area connected to the outlet and the inlet of the electrolyte tank, the electrolyte being a slurry of a first electrochemically active redox reactant adsorbed on carbon particles suspended in a solvent;
a gas diffusion electrode connected to the input of the flow path parallel to the flow path in which the electrolyte circulates for introducing flow of a gas parallel to and on the opposite side of the membrane from the flow of electrolyte, the gas being purged through the output of the flow path, the gas including a second electrochemically active redox reactant forming a redox couple with the first redox reactant, a redox reaction occurring across the ion-selective membrane to induce a voltage differential between the anode and the cathode; and
output conductors connected to the anode and the cathode, respectively, to output current from the at least one flow cell.

2. The hybrid air-slurry flow cell battery as recited in claim 1, further comprising a pump for driving recirculation of the electrolyte through the electrolyte tank and the core area flow path.

3. The hybrid air-slurry flow cell battery as recited in claim 1, wherein the electrolyte tank is connected to the anolyte flow path for circulating a flow of the electrolyte slurry through the core area.

4. The hybrid air-slurry flow cell battery as recited in claim 3, wherein the gas diffusion electrode is connected to the input of the catholyte flow path.

5. The hybrid air-slurry flow cell battery as recited in claim 4, wherein the gas comprises ambient air.

6. The hybrid air-slurry flow cell battery as recited in claim 4, wherein the gas comprises elemental oxygen.

7. The hybrid air-slurry flow cell battery as recited in claim 3, wherein the first electrochemically active redox reactant comprises a sulfide salt.

8. The hybrid air-slurry flow cell battery as recited in claim 3, wherein the slurry comprises sodium sulfide and particles of activated carbon suspended in an aqueous solution of a salt selected from the group consisting of potassium hydroxide, sodium hydroxide and a combination thereof.

9. The hybrid air-slurry flow cell battery as recited in claim 3, wherein the first electrochemically active redox reactant has a redox potential ranging between 0 V/RHE in aqueous solution to −1 V/RHE in aqueous solution.

10. The hybrid air-slurry flow cell battery as recited in claim 3, wherein the first electrochemically active redox reactant has a redox potential ranging between 0 V/RHE in non-aqueous solution to −3 V/RHE in non-aqueous solution.

11. The hybrid air-slurry flow cell battery as recited in claim 3, wherein the first electrochemically active redox reactant includes carbon particles having a concentration of between 0 wt % and 10 wt % with respect to the electrolyte.

12. The hybrid air-slurry flow cell battery as recited in claim 11, wherein each said carbon particle has a surface area density ranging between 100 and 2000 m²/g.

13. The hybrid air-slurry flow cell battery as recited in claim 12, wherein the carbon particles have forms selected from the group consisting of spheres, cubes, rods, needles, tubes and combinations thereof.

14. A hybrid air-slurry flow cell battery as recited in claim 1, wherein the electrolyte tank is connected to the catholyte flow path for circulating a flow of the electrolyte slurry through the core area.

15. The hybrid air-slurry flow cell battery as recited in claim 14, wherein the gas diffusion electrode is connected to the input of the anolyte flow path.
